(19) United States
(12) Patent Application Publication
(10) Pub. No.: US 2008/0052523 A1
(43) Pub. Date: Feb. 28, 2008

(54) Method For Coding And Decoding Information Containing In Any Order Any or All Upper or Lower Case Letters, with or without Numbers, with or without Symbols, with or without Punctuation Marks, with or without Spaces, with or without Special Characters, with or without Graphic Symbols, and/or with or without Any Other Characters Found On Any Keyboard In Any Language Using a Substitution Process.

(76) Inventor: Mark Les Kaluza, Streamwood, IL (US)

Correspondence Address: MARK LES KALUZA, 126 MCCABE DR., STREAMWOOD, IL, 60107, US

(21) Appl. No.: 11/466,394

(22) Filed: Aug. 22, 2006

(51) Int. Cl. H04L 9/00

(52) U.S. Cl. 713/183

(57) ABSTRACT

A Method for coding and decoding information utilizing a Character Set containing in any order any or all upper or lower case letters, with or without numbers, with or without symbols, with or without punctuation marks, with or without spaces, with or without special characters, with or without graphic symbols, and/or with or without any other characters found on any keyboard in any language; a Character Value Set in which each character within the selected Character Set is assigned a positive numerical value from 1 up; a Mixed Character Sequence Set in which the characters within the selected Character Set are listed in any conceivable sequential order; a Password composed of as little as one or up to as many characters as there are within the selected Character Set which characters can be used once or repeatedly and which each of the characters has an assigned numerical value as determined by a selected Numerical Character Sequence Set; and a Substitution Process in which a Substitution Character is assigned for each of the characters in the Character Set that will be used for coding and decoding information.

The Method for Coding And Decoding Information Containing In Any Order Any or All Upper or Lower Case Letters, with or without Numbers, with or without Symbols, with or without Punctuation Marks, with or without Spaces, with or without Special Characters, with or without Graphic Symbols, and/or with or without Any Other Characters Found On Any Keyboard In Any Language Using a Substitution Process is built around four variables.

The first variable is a unique Character Set. Character Set is a set of any number of non-reoccurring characters that can contain in any order any or all upper or lower case letters, with or without numbers, with or without symbols, with or without punctuation marks, with or without spaces, with or without special characters, with or without graphic symbols, and/or with or without any other characters found on any keyboard in any language. Once the Character Set is created, it is that Character Set that is utilized by the Method.

There is a vast number of Character Sets. In order to describe the Method in a simple way, a Character Set composed of forty three (43) characters found on any English language computer keyboard or cellular phone will be used. See Table 1.

TABLE 1

| A | B | C | D | E | F | G | H | I | J | K | L | M | N | O |
|---|---|---|---|---|---|---|---|---|---|---|---|---|---|---|
| P | Q | R | S | T | U | V | W | X | Y | Z | 1 | 2 | 3 | 4 |
| 5 | 6 | 7 | 8 | 9 | 0 | spc* | ? | ! | $ | % | ( | ) | | |

*spc = SPACE

The second variable is a Character Value Set. In a Character Value Set, each character within the selected Character Set is assigned a positive numerical value from 1 up. The numerical value assigned to each character within the Character Value Set may but does not have to be unique. Unique means that the same numerical value may be assigned to more then one character within the selected Character Set.

There is an infinite number of Character Value Sets. In order to describe the Method in a simple way, two Character Value Sets based on the selected Character Set shown in Table 1 will be used: Character Value Set Example 1 and Character Value Set Example 2.

In the Character Value Set Example 1, each of the forty three (43) characters from Table 1 is assigned a unique to each character numerical values from one (1) through forty three (43). See Table 2.

### Character Value Set Example 1

TABLE 2

| A = 1 | B = 2 | C = 3 | D = 4 | E = 5 |
|---|---|---|---|---|
| F = 6 | G = 7 | H = 8 | I = 9 | J = 10 |
| K = 11 | L = 12 | M = 13 | N = 14 | O = 15 |
| P = 16 | Q = 17 | R = 18 | S = 19 | T = 20 |
| U = 21 | V = 22 | W = 23 | X = 24 | Y = 25 |
| Z = 26 | 1 = 27 | 2 = 28 | 3 = 29 | 4 = 30 |
| 5 = 31 | 6 = 32 | 7 = 33 | 8 = 34 | 9 = 35 |
| 0 = 36 | spc = 37 | ? = 38 | ! = 39 | $ = 40 |
| % = 41 | ( = 42 | ) = 43 | | |

In the Character Value Set Example 2, each of the forty three (43) characters from Table 1 is assigned a numerical value of one (1) through five (5). See Table 3.

### Character Value Set Example 2

TABLE 3

| A = 1 | B = 2 | C = 3 | D = 4 | E = 5 |
|---|---|---|---|---|
| F = 1 | G = 2 | H = 3 | I = 4 | J = 5 |
| K = 1 | L = 2 | M = 3 | N = 4 | O = 5 |
| P = 1 | Q = 2 | R = 3 | S = 4 | T = 5 |
| U = 1 | V = 2 | W = 3 | X = 4 | Y = 5 |
| Z = 1 | 1 = 2 | 2 = 3 | 3 = 4 | 4 = 5 |
| 5 = 1 | 6 = 2 | 7 = 3 | 8 = 4 | 9 = 5 |
| 0 = 1 | spc = 2 | ? = 3 | ! = 4 | $ = 5 |
| % = 1 | ( = 2 | ) = 3 | | |

The third variable is a Mixed Character Sequence Set. Mixed Character Sequence Set is created by listing characters from the selected Character Set in any conceivable sequential order. In order to describe the Method in a simple way, the characters from the Character Set in Table 1 are listed in sequential order to create the Mixed Character Sequence Set as illustrated in Table 4.

TABLE 4

| Sequential Order of | Mixed Character |
|---|---|
| Mixed Characters | Sequence Set |
| 1^{st} | 1 |
| 2^{nd} | 2 |
| 3^{rd} | 3 |
| 4^{th} | 4 |
| 5^{th} | 5 |
| 6^{th} | 6 |
| 7^{th} | 7 |
| 8^{th} | 8 |
| 9^{th} | 9 |
| 10^{th} | 0 |
| 11^{th} | A |
| 12^{th} | B |
| 13^{th} | C |
| 14^{th} | D |
| 15^{th} | E |
| 16^{th} | F |
| 17^{th} | G |
| 18^{th} | H |
| 19^{th} | I |
| 20^{th} | J |
| 21^{st} | K |
| 22^{nd} | L |
| 23^{rd} | M |
| 24^{th} | N |
| 25^{th} | O |
| 26^{th} | P |
| 27^{th} | Q |
| 28^{th} | R |
| 29^{th} | S |
| 30^{th} | T |
| 31^{st} | U |
| 32^{nd} | V |
| 33^{rd} | W |
| 34^{th} | X |
| 35^{th} | Y |
| 36^{th} | Z |
| 37^{th} | spc |
| 38^{th} | ? |
| 39^{th} | ! |
| 40^{th} | $ |
| 41^{st} | % |
| 42^{nd} | ( |
| 43^{rd} | ) |

The fourth variable is a Password. Password is an assortment of characters from within the selected Character Set. Password can be composed of as little as one or up to as many characters as there are within the selected Character Set. The characters within a Password may be used once or repeatedly. The Method requires that a Character Sequence must be created meaning that the number of characters within a Password equals the number of characters within the selected Character Set. When the number of characters within a Password is less than the number of characters that there are within the selected Character Set, a formula has to be used. In that formula, the number of characters within the selected Character Set is divided by the number of characters within a Password. The result of that formula determines how many times the Password has to be repeated in order to obtain the number of characters contained within the selected Character Set. Once the formula is computed, the characters within the Password are repeated by the result of the formula and a Character Sequence can be created.

There is a vast number of Passwords. In order to describe the Method in a simple way, one Password will be used. That Password will use the phrase 1ST PASSWORD.

There are forty three (43) characters within the selected Character Set as shown in Table 1. The sample Passwords 1ST PASSWORD contains twelve (12) characters. Therefore, in order to obtain the Character Sequence of 43, the number 43 needs to be divided by 12 that equals to 3.6. Therefore, the Password 1ST PASSWORD has to be repeated 3.6 times.

Each character in the Character Sequence translates into a numerical value based on the Character Value Set.

The following sequence of numbers illustrates how 1ST PASSWORD translates into its unique sequence of numerical values in accordance with the Character Value Set Example 1.

| | | | | | | | | | | | |
|---|---|---|---|---|---|---|---|---|---|---|---|
| 1 = 27 | S = 19 | T = 20 | spc = 37 | P = 16 | A = 1 | S = 19 | S = 19 | W = 23 | O = 15 | R = 18 | D = 4 |

In order to obtain forty three numerical values, that unique sequence above has to be repeated 3.6 times as illustrated below to create its corresponding Numerical Character Sequence. See Table 5.

### Numerical Character Sequence for Sample Password 1ST PASSWORD with Character Value Set Example 1

TABLE 5

| 1^{st} | 2^{nd} | 3^{rd} | 4^{th} | 5^{th} | 6^{th} | 7^{th} | 8^{th} | 9^{th} | 10^{th} | 11^{th} | 12^{th} |
|---|---|---|---|---|---|---|---|---|---|---|---|
| 1 = 27 | S = 19 | T = 20 | spc = 37 | P = 16 | A = 1 | S = 19 | S = 19 | W = 23 | O = 15 | R = 18 | D = 4 |
| 13^{th} | 14^{th} | 15^{th} | 16^{th} | 17^{th} | 18^{th} | 19^{th} | 20^{th} | 21^{st} | 22^{nd} | 23^{rd} | 24^{th} |
| 1 = 27 | S = 19 | T = 20 | spc = 37 | P = 16 | A = 1 | S = 19 | S = 19 | W = 23 | O = 15 | R = 18 | D = 4 |
| 25^{th} | 26^{th} | 27^{th} | 28^{th} | 29^{th} | 30^{th} | 31^{st} | 32^{nd} | 33^{rd} | 34^{th} | 35^{th} | 36^{th} |
| 1 = 27 | S = 19 | T = 20 | spc = 37 | P = 16 | A = 1 | S = 19 | S = 19 | W = 23 | O = 15 | R = 18 | D = 4 |

| 37^{th} | 38^{th} | 39^{th} | 40^{th} | 41^{st} | 42^{nd} | 43^{rd} |
|---|---|---|---|---|---|---|
| 1 = 27 | S = 19 | T = 20 | spc = 37 | P = 16 | A = 1 | S = 19 |

The following sequence of numbers illustrates how 1ST PASSWORD translates into its unique Numerical Character Sequence in accordance with the Character Value Set Example 2.

| | | | | | | | | | | | |
|---|---|---|---|---|---|---|---|---|---|---|---|
| 1 = 2 | S = 4 | T = 5 | spc = 2 | P = 1 | A = 1 | S = 4 | S = 4 | W = 3 | O = 5 | R = 3 | D = 4 |

In order to obtain forty three numerical values, that unique sequence above has to be repeated 3.6 times as illustrated below to create its corresponding Numerical Character Sequence. See Table 6.

### Numerical Character Sequence for Sample Password 1ST PASSWORD with Character Value Set Example 2

TABLE 6

| 1^{st} | 2^{nd} | 3^{rd} | 4^{th} | 5^{th} | 6^{th} | 7^{th} | 8^{th} | 9^{th} | 10^{th} | 11^{th} | 12^{th} |
|---|---|---|---|---|---|---|---|---|---|---|---|
| 1 = 2 | S = 4 | T = 5 | spc = 2 | P = 1 | A = 1 | S = 4 | S = 4 | W = 3 | O = 5 | R = 3 | D = 4 |
| 13^{th} | 14^{th} | 15^{th} | 16^{th} | 17^{th} | 18^{th} | 19^{th} | 20^{th} | 21^{st} | 22^{nd} | 23^{rd} | 24^{th} |
| 1 = 2 | S = 4 | T = 5 | spc = 2 | P = 1 | A = 1 | S = 4 | S = 4 | W = 3 | O = 5 | R = 3 | D = 4 |
| 25^{th} | 26^{th} | 27^{th} | 28^{th} | 29^{th} | 30^{th} | 31^{st} | 32^{nd} | 33^{rd} | 34^{th} | 35^{th} | 36^{th} |
| 1 = 2 | S = 4 | T = 5 | spc = 2 | P = 1 | A = 1 | S = 4 | S = 4 | W = 3 | O = 5 | R = 3 | D = 4 |

| 37^{th} | 38^{th} | 39^{th} | 40^{th} | 41^{st} | 42^{nd} | 43^{rd} |
|---|---|---|---|---|---|---|
| 1 = 2 | S = 4 | T = 5 | spc = 2 | P = 1 | A = 1 | S = 4 |

Once the four variables are established: a unique Character Set, a unique Character Value Set, a unique Mixed Character Sequence Set, and a unique Password along with its corresponding Numerical Character Sequence, the Substitution Process begins.

The Substitution Process is a process in which a Substitution Character is assigned for each of the characters in the Character Set that will be used for coding and decoding information. In the Substitution Process, four columns need to be created: Columns A, B, C, and D.

Column A, the Sequential Order of Mixed Characters, lists the sequential order of the characters in the Mixed Character Sequence Set which are located in Column B. In order to describe the Method in a simple way, Sequential Order of Mixed Characters and the Mixed Character Sequence Set illustrated in Table 4 will be used. Column C is a mirror image of Column B. Column D is the last column. The purpose of Column D is to list the Substitution Characters for each of the Characters in Column C.

The Substitution Character Set in column D is created by using consecutive Numerical Character Sequence of the Password to identify the corresponding characters in Column B to become the next character in Column D. As the Substitution Process continues, the number of characters in Column B decreases along with their corresponding sequential order in Column A and the number of characters in Column D increases creating the Substitution Character Set in Column D. Once all of the characters in Column B are removed, all of the characters in Column C have a corresponding Substitution Character in Column D and the Substitution Character Set is created. Once the Substitution Character Set is created, any information utilizing characters from within the Character Set can be coded and decoded.

There are many ways of conducting the Substitution Process. In order to describe the System in a simple way, as an example, two Substitution Processes will be used.

The FIRST sample Substitution Process is based on selection of Substitution Characters by utilizing the Numerical Character Sequence count always starting from the very first available character in Column B. The Numerical Character Sequence count always starts from number 1.

The SECOND sample Substitution Process is based on selection of Substitution Characters in Column B by utilizing the Numerical Character Sequence count starting with number 1 from the next character following a character last moved from Column B to Column D. The First Numerical Character Sequence count always starting from the very first available character in Column B.

Both of these sample Substitution Processes will be described step by step.

The Coding Process is based on substitution of characters in Column C with corresponding Characters in Column D.

The Decoding Process is based on substitution of characters from Column D with the corresponding Characters in Column C.

In order to decode information, all four variables used to code that information have to be the same: the Character Set, the Character Value Set, the Mixed Character Sequence Set, and the Password.

### EXAMPLE 1

EXAMPLE 1 illustrates step by step Substitution Process utilizing the sample Character Set illustrated in Table 1, sample Character Value Set Example 1 illustrated in Table 2, sample Mixed Character Set illustrated in Table 4, sample Password 1ST PASSWORD along with its Numerical Character Sequence for Sample Password 1ST PASSWORD with Character Value Set Example 1 illustrated in Table 5, and the FIRST sample Substitution Process.
1. The first character in 1ST PASSWORD is “1” with a numerical value of 27. The 27^{th} character in Column B is “Q”. Following the Substitution Process, “Q” is removed from Column B and moved to Column D. As the result, “Q” becomes the Substitution Character for the number “1”. See Table 7.
2. The second character in 1ST PASSWORD is “S” with a numerical value of 19. The 19^{th} character in Column B is “I”. Following the Substitution Process, “I” is removed from Column B and moved to Column D. As the result, “I” becomes the Substitution Character for the number “2”. See Table 8.

TABLE 7

| A | B | C | D |
|---|---|---|---|
| 1^{st} | 1 | 1 | Q |
| 2^{nd} | 2 | 2 | |
| 3^{rd} | 3 | 3 | |
| 4^{th} | 4 | 4 | |
| 5^{th} | 5 | 5 | |
| 6^{th} | 6 | 6 | |
| 7^{th} | 7 | 7 | |
| 8^{th} | 8 | 8 | |
| 9^{th} | 9 | 9 | |
| 10^{th} | 0 | 0 | |
| 11^{th} | A | A | |
| 12^{th} | B | B | |
| 13^{th} | C | C | |
| 14^{th} | D | D | |
| 15^{th} | E | E | |
| 16^{th} | F | F | |
| 17^{th} | G | G | |
| 18^{th} | H | H | |
| 19^{th} | I | I | |
| 20^{th} | J | J | |
| 21^{st} | K | K | |
| 22^{nd} | L | L | |
| 23^{rd} | M | M | |
| 24^{th} | N | N | |
| 25^{th} | O | O | |
| 26^{th} | P | P | |
| [symbol] | [symbol] | Q | |
| 28^{th} | R | R | |
| 29^{th} | S | S | |
| 30^{th} | T | T | |
| 31^{st} | U | U | |
| 32^{nd} | V | V | |
| 33th | W | W | |
| 34^{th} | X | X | |
| 35^{th} | Y | Y | |
| 36^{th} | Z | Z | |
| 37^{th} | spc | spc | |
| 38^{th} | ? | ? | |
| 39^{th} | ! | ! | |
| 40^{th} | $ | $ | |
| 41^{st} | % | % | |
| 42^{nd} | ( | ( | |
| 43^{rd} | ) | ) | |

TABLE 8

| A | B | C | D |
|---|---|---|---|
| 1^{st} | 1 | 1 | Q |
| 2^{nd} | 2 | 2 | I |
| 3^{rd} | 3 | 3 | |
| 4^{th} | 4 | 4 | |
| 5^{th} | 5 | 5 | |
| 6^{th} | 6 | 6 | |
| 7^{th} | 7 | 7 | |
| 8^{th} | 8 | 8 | |
| 9^{th} | 9 | 9 | |
| 10^{th} | 0 | 0 | |
| 11^{th} | A | A | |
| 12^{th} | B | B | |
| 13^{th} | C | C | |
| 14^{th} | D | D | |
| 15^{th} | E | E | |
| 16^{th} | F | F | |
| 17^{th} | G | G | |
| 18^{th} | H | H | |
| [symbol] | [symbol] | I | |
| 20^{th} | J | J | |
| 21^{st} | K | K | |
| 22^{nd} | L | L | |
| 23^{rd} | M | M | |
| 24^{th} | N | N | |
| 25^{th} | O | O | |
| 26^{th} | P | P | |
| | | Q | |
| 27^{th} | R | R | |
| 28^{th} | S | S | |
| 29^{th} | T | T | |
| 30^{th} | U | U | |
| 31^{st} | V | V | |
| 32^{nd} | W | W | |
| 33^{th} | X | X | |
| 34^{th} | Y | Y | |
| 35^{th} | Z | Z | |
| 36^{th} | spc | spc | |
| 37^{th} | ? | ? | |
| 38^{th} | ! | ! | |
| 39^{th} | $ | $ | |
| 40^{th} | % | % | |
| 41^{st} | ( | ( | |
| 42^{nd} | ) | ) | |

3. The third character in 1ST PASSWORD is “T” with a numerical value of 20. The 20^{th} character in Column B is “K”. Following the Substitution Process, “K” is removed from Column B and moved to Column D. As the result, “K” becomes the Substitution Character for the number “3”.
4. The fourth character in 1ST PASSWORD is a space with a numerical value of 37. The 37^{th} character in Column B is “$”. Following the Substitution Process, “$” is removed from Column B and moved to Column D. As the result, “$” becomes the Substitution Character for the number “4”.
5. The fifth character in 1ST PASSWORD is “P” with a numerical value of 16. The 16^{th} character in Column B is “F”. Following the Substitution Process, “F” is removed from Column B and moved to Column D. As a result, “F” becomes the Substitution Character for the number “5”.
6. The sixth character in 1ST PASSWORD is “A” with a numerical value of 1. The 1^{st} character in Column B is “1”. Following the Substitution Process “1” is removed from Column B and moved to Column D. As a result, “1” becomes the Substitution Character for the number “6”.
7. The seventh character in 1ST PASSWORD is “S” with a numerical value of 19. The 19^{th} character in Column B is “M”. Following the Substitution Process, “M” is removed from Column B and moved to Column D. As the result, “M” becomes the Substitution Character for the number “7”.
8. The eight character in 1ST PASSWORD is also “S” with a numerical value of 19. The 19^{th} character in Column B is “N”. Following the Substitution Process, “N” is removed from Column B and moved to Column D. As the result, “N” becomes the Substitution Character for the number “8”.
9. The ninth character in 1ST PASSWORD is “W” with a numerical value of 23. The 23^{rd} character in Column B is “T”. Following the Substitution Process, “T” is removed from Column B and moved to Column D. As the result, “T” becomes the Substitution Character for the number “9”.
10. The tenth character in 1ST PASSWORD is “O” with a numerical value of 15. The 15^{th} character in Column B is “G”. Following the Substitution Process, “G” is removed from Column B and moved to Column D. As the result, “G” becomes the Substitution Character for the number “0”.
11. The eleventh character in 1ST PASSWORD is “R” with a numerical value of 18. The 18^{th} character in Column B is “O”. Following the Substitution Process, “O” is removed from Column B and moved to Column D. As the result, “O” becomes the Substitution Character for the letter “A”.
12. The twelfth character in 1ST PASSWORD is “D” with a numerical value of 4. The 4^{th} character in Column B is “5”. Following the Substitution Process, “5” is removed from Column B and moved to Column D. As the result, “5” becomes the Substitution Character for the letter “B”.
13. As a reminder, there are twelve characters in 1ST PASSWORD. Therefore, in order to obtain the thirteenth character, the “Numerical Character Sequence for Sample Password 1ST PASSWORD with Character Value Set Example 1” has to be used.
The thirteenth character Numerical Character Sequence for Sample Password: 1ST PASSWORD and Character Value Set Example 1 is “1” with a numerical value of 27. The 27^{th} character in Column B is “?”. Following the Substitution Process, “?” is removed from Column B and moved to Column D. As the result, “?” becomes the Substitution Character for the letter “C”.
14. The fourteenth character in the “Numerical Character Sequence for Sample Password 1ST PASSWORD with Character Value Set Example 1” is “S” with a numerical value of 19. The 19^{th} character in Column B is “S”. Following the Substitution Process, “S” is removed from Column B and moved to Column D. As the result, “S” becomes the Substitution Character for the letter “D”.
15. The fifteenth character in the “Numerical Character Sequence for Sample Password 1ST PASSWORD with Character Value Set Example 1” is “T” with a numerical value of 20. The 20^{th} character in Column B is “V”. Following the Substitution Process, “V” is removed from Column B and moved to Column D. As the result, “V” becomes the Substitution Character for the letter “E”.
16. The sixteenth character in the “Numerical Character Sequence for Sample Password 1ST PASSWORD with Character Value Set Example 1” is “spc” with a numerical value of 37. Due to the ongoing Substitution Process, there are only twenty eight (28) characters remaining in Column B. Therefore, to obtain a character the 37^{th} character, the count in Column A has to be resumed from the top. The 37^{th} character in Column B is “A”. Following the Substitution Process, “A” is removed from Column B and moved to Column D. As the result, “A” becomes the Substitution Character for the letter “F”. See Table 9.
Note 1. In any instant when the numerical value of a character in the Numerical Character Sequence for a Password is greater than the number of characters remaining in Column B, the count in Column A has to be repeated from the top of the Column as many times as it is necessary to obtain that numerical value in order to identify the corresponding character in Column B. See Table 9.

TABLE 9

| A | A | B | C | D |
|---|---|---|---|---|
| | | | 1 | Q |
| 1^{st} | 29^{th} | 2 | 2 | I |
| 2^{nd} | 30^{th} | 3 | 3 | K |
| 3^{rd} | 31^{st} | 4 | 4 | $ |
| | | | 5 | F |
| 4^{th} | 32^{nd} | 6 | 6 | 1 |
| 5^{th} | 33^{rd} | 7 | 7 | M |
| 6^{th} | 34^{th} | 8 | 8 | N |
| 7^{th} | 35^{th} | 9 | 9 | T |
| 8^{th} | 36^{th} | 0 | 0 | G |
| 9^{th} | [symbol] | [symbol] | A | O |
| 10^{th} | | B | B | 5 |
| 11^{th} | | C | C | ? |
| 12^{th} | | D | D | S |
| 13^{th} | | E | E | V |
| | | | F | A |
| | | | G | |
| 14^{th} | | H | H | |
| | | | I | |
| 15^{th} | | J | J | |
| | | | K | |
| 16^{th} | | L | L | |
| | | | M | |
| | | | N | |
| | | | O | |
| 17^{th} | | P | P | |
| | | | Q | |
| 18^{th} | | R | R | |
| | | | S | |
| | | | T | |
| 19^{th} | | U | U | |
| | | | V | |
| 20^{th} | | W | W | |
| 21^{st} | | X | X | |
| 22^{nd} | | Y | Y | |
| 23^{rd} | | Z | Z | |
| 24^{th} | | spc | spc | |
| | | | ? | |
| 25^{th} | | ! | ! | |
| | | | $ | |
| 26^{th} | | % | % | |
| 27^{th} | | ( | ( | |
| 28^{th} | | ) | ) | |

17. The seventeenth character in the “Numerical Character Sequence for Sample Password 1ST PASSWORD with Character Value Set Example 1” is “P” with a numerical value of 16. The 16^{th} character in Column B is “P”. Following the Substitution Process, “P” is removed from Column B and moved to Column D. As the result, “P” becomes the Substitution Character for the letter “G”.
18. The eighteenth character in the “Numerical Character Sequence for Sample Password 1ST PASSWORD with Character Value Set Example 1” is “A” with a numerical value of 1. The 1^{st} character in Column B is “2”. Following the Substitution Process, “2” is removed from Column B and moved to Column D. As the result, “2” becomes the Substitution Character for the letter “H”.
19. The nineteenth character in the “Numerical Character Sequence for Sample Password 1ST PASSWORD with Character Value Set Example 1” is “S” with a numerical value of 19. The 19^{th} character in Column B is “Y”. Following the Substitution Process, “Y” is removed from Column B and moved to Column D. As the result, “Y” becomes the Substitution Character for the letter “I”.
20. The twentieth character in the “Numerical Character Sequence for Sample Password 1ST PASSWORD with Character Value Set Example 1” is also “S” with a numerical value of 19. The 19^{th} character in Column B is “Z”. Following the Substitution Process, “Z” is removed from Column B and moved to Column D. As the result, “Z” becomes the Substitution Character for the letter “J”.
21. The twenty first character in the “Numerical Character Sequence for Sample Password 1ST PASSWORD with Character Value Set Example 1” is “W” with a numerical value of 23. The 23^{rd} character in Column B is “)”. Following the Substitution Process, “)” is removed from Column B and moved to Column D. As the result, “)” becomes the Substitution Character for the letter “K”.
22. The twenty second character in the “Numerical Character Sequence for Sample Password 1ST PASSWORD with Character Value Set Example 1” is “O” with a numerical value of 15. The 15^{th} character in Column B is “R”. Following the Substitution Process, “R” is removed from Column B and moved to Column D. As the result, “R” becomes the Substitution Character for the letter “L”.
23. The twenty third character in the “Numerical Character Sequence for Sample Password 1ST PASSWORD with Character Value Set Example 1” is “R” with a numerical value of 18. The 18^{th} character in Column B is “spc”. Following the Substitution Process, “spc” is removed from Column B and moved to Column D. As the result, “spc” becomes the Substitution Character for the letter “M”.
24. The twenty fourth character in the “Numerical Character Sequence for Sample Password 1ST PASSWORD with Character Value Set Example 1” is “D” with a numerical value of 4. The 4^{th} character in Column B is “7”. Following the Substitution Process, “7” is removed from Column B and moved to Column D. As the result, “7” becomes the Substitution Character for the letter “N”.
25. The twenty fifth character in the “Numerical Character Sequence for Sample Password 1ST PASSWORD with Character Value Set Example 1” is “1” with a numerical value of 27. The 27^{th} character in Column B is “C”. Following the Substitution Process, “C” is removed from Column B and moved to Column D. As the result, “C” becomes the Substitution Character for the letter “O”. See Note 1.
26. The twenty sixth character in the “Numerical Character Sequence for Sample Password 1ST PASSWORD with Character Value Set Example 1” is “S” with a numerical value of 19. The 19^{th} character in Column B is “3”. Following the Substitution Process, “3” is removed from Column B and moved to Column D. As the result, “3” becomes the Substitution Character for the letter “P”. See Note 1.
27. The twenty seventh character in the “Numerical Character Sequence for Sample Password 1ST PASSWORD with Character Value Set Example 1” is “T” with a numerical value of 20. The 20^{th} character in Column B is “8”. Following the Substitution Process, “8” is removed from Column B and moved to Column D. As the result, “8” becomes the Substitution Character for the letter “Q”. See Note 1.
28. The twenty eight character in the “Numerical Character Sequence for Sample Password 1ST PASSWORD with Character Value Set Example 1” is “spc” with a numerical value of 37. The 37^{th} character in Column B is “B”. Following the Substitution Process, “B” is removed from Column B and moved to Column D. As the result, “B” becomes the Substitution Character for the letter “R”. See Note 1.
29. The twenty ninth character in the “Numerical Character Sequence for Sample Password 1ST PASSWORD with Character Value Set Example 1” is “P” with a numerical value of 16. The 16^{th} character in Column B is “4”. Following the Substitution Process, “4” is removed from Column B and moved to Column D. As the result, “4” becomes the Substitution Character for the letter “S”. See Note 1.
30. The thirtieth character in the “Numerical Character Sequence for Sample Password 1ST PASSWORD with Character Value Set Example 1” is “A” with a numerical value of 1. The 1^{st} character in Column B is “6”. Following the Substitution Process, “6” is removed from Column B and moved to Column D. As the result, “6” becomes the Substitution Character for the letter “T”.
31. The thirty first character in the “Numerical Character Sequence for Sample Password 1ST PASSWORD with Character Value Set Example 1” is “S” with a numerical value of 19. The 19^{th} character in Column B is “J”. Following the Substitution Process, “J” is removed from Column B and moved to Column D. As the result, “J” becomes the Substitution Character for the letter “U”. See Note 1.
32. The thirty second character in the “Numerical Character Sequence for Sample Password 1ST PASSWORD with Character Value Set Example 1” is also “S” with a numerical value of 19. The 19^{th} character in Column B is “U”. Following the Substitution Process, “U” is removed from Column B and moved to Column D. As the result, “U” becomes the Substitution Character for the letter “V”. See Note 1.
33. The thirty third character in the “Numerical Character Sequence for Sample Password 1ST PASSWORD with Character Value Set Example 1” is “W” with a numerical value of 23. The 23^{rd} character in Column B is “9”. Following the Substitution Process, “9” is removed from Column B and moved to Column D. As the result, “9” becomes the Substitution Character for the letter “W”. See Note 1.
34. The thirty fourth character in the “Numerical Character Sequence for Sample Password 1ST PASSWORD with Character Value Set Example 1” is also “O” with a numerical value of 15. The 15^{th} character in Column B is “L”. Following the Substitution Process, “L” is removed from Column B and moved to Column D. As the result, “L” becomes the Substitution Character for the letter “X”. See Note 1.
35. The thirty fifth character in the “Numerical Character Sequence for Sample Password 1ST PASSWORD with Character Value Set Example 1” is “R” with a numerical value of 18. The 18^{th} character in Column B is “(”. Following the Substitution Process, “(” is removed from Column B and moved to Column D. As the result, “(” becomes the Substitution Character for the letter “Y”. See Note 1.
36. The thirty sixth character in the “Numerical Character Sequence for Sample Password 1ST PASSWORD with Character Value Set Example 1” is “D” with a numerical value of 4. The 4^{th} character in Column B is “H”. Following the Substitution Process, “H” is removed from Column B and moved to Column D. As the result, “H” becomes the Substitution Character for the letter “Z”.
37. The thirty seventh character in the “Numerical Character Sequence for Sample Password 1ST PASSWORD with Character Value Set Example 1” is “1” with a numerical value of 27. The 27^{th} character in Column B is “!”. Following the Substitution Process, “!” is removed from Column B and moved to Column D. As the result, “!” becomes the Substitution Character for the “spc”. See Note 1.
38. The thirty eighth character in the “Numerical Character Sequence for Sample Password 1ST PASSWORD with Character Value Set Example 1” is “S” with a numerical value of 19. The 19^{th} character in Column B is “0”. Following the Substitution Process, “0” is removed from Column B and moved to Column D. As the result, “0” becomes the Substitution Character for the “?”. See Note 1.
39. The thirty ninth character in the “Numerical Character Sequence for Sample Password 1ST PASSWORD with Character Value Set Example 1” is “T” with a numerical value of 20. The 20^{th} character in Column B is “%”. Following the Substitution Process, “%” is removed from Column B and moved to Column D. As the result, “%” becomes the Substitution Character for the “!”. See Note 1.
40. The fortieth character in the “Numerical Character Sequence for Sample Password 1ST PASSWORD with Character Value Set Example 1” is “spc” with a numerical value of 37. The 37^{th} character in Column B is “D”. Following the Substitution Process, “D” is removed from Column B and moved to Column D. As the result, “D” becomes the Substitution Character for the “$”. See Note 1.
41. The forty first character in the “Numerical Character Sequence for Sample Password 1ST PASSWORD with Character Value Set Example 1” is “P” with a numerical value of 16. The 16^{th} character in Column B is “E”. Following the Substitution Process, “E” is removed from Column B and moved to Column D. As the result, “E” becomes the Substitution Character for the “%”. See Note 1.
42. The forty second character in the “Numerical Character Sequence for Sample Password 1ST PASSWORD with Character Value Set Example 1” is “A” with a numerical value of 1. The 1^{st} character in Column B is “W”. Following the Substitution Process, “W” is removed from Column B and moved to Column D. As the result, “W” becomes the Substitution Character for the “(”. See Table 42.
43. The forty third and last character in the “Numerical Character Sequence for Sample Password 1ST PASSWORD with Character Value Set Example 1” is “S” with a numerical value of 19. The last character in Column B is “X”. As the result, “X” becomes the Substitution Character for the “)” and completes the Substitution Process. See Note 1.
44. Table 6 represents the Final Coding Sequence for Example 1 utilizing the sample Character Set illustrated in Table 1, sample Character Value Set Example 1 illustrated in Table 2, sample Mixed Character Set illustrated in Table 4, sample Password 1ST PASSWORD along with its Numerical Character Sequence for Sample Password 1ST PASSWORD with Character Value Set Example 1 illustrated in Table 5, and the FIRST sample Substitution Process. See Table 10.

### Final Coding Sequence for Example 1

TABLE 10

| Column C | Column D |
|---|---|
| 1 | Q |
| 2 | I |
| 3 | K |
| 4 | $ |
| 5 | F |
| 6 | 1 |
| 7 | M |
| 8 | N |
| 9 | I |
| 0 | G |
| A | O |
| B | 5 |
| C | ? |
| D | S |
| E | V |
| F | A |
| G | P |
| H | 2 |
| I | Y |
| J | Z |
| K | ) |
| L | R |
| M | spc |
| N | 7 |
| O | C |
| P | 3 |
| Q | 8 |
| R | B |
| S | 4 |
| T | 6 |
| U | J |
| V | U |
| W | 9 |
| X | L |
| Y | ( |
| Z | H |
| spc | ! |
| ? | 0 |
| ! | % |
| $ | D |
| % | E |
| ( | W |
| ) | X |

The Coding Process is based on substitution of characters in Column C with corresponding Characters in Column D. The Decoding Process is based on substitution of characters from Column D with the corresponding Characters in Column C.

To demonstrate the coding process using the Final Coding Sequence for Example 1 as listed in Table 10, the phrase

### SAMPLE CODING OF CHARACTER SET ABCDEFGHIJKLMNOPQRSTUVWXYZ1234567890

?!$%( )
translates into
4O3RV!?CSY7P!CA!?2OBO?6VB!4V6!O5?SVAP2YZ)R
7C38B46JU9L(HQIK$F1MNTG!0%DEWX

### EXAMPLE 2

EXAMPLE 2 illustrates step by step Substitution Process utilizing the sample Character Set illustrated in Table 1, sample Character Value Set Example 1 illustrated in Table 2, sample Mixed Character Set illustrated in Table 4, sample Password 1ST PASSWORD along with its Numerical Character Sequence for Sample Password 1ST PASSWORD with Character Value Set Example 1 illustrated in Table 5, and the SECOND sample Substitution Process.
1. The first character in 1ST PASSWORD is “1” with a numerical value of 27. The 27^{th} character in Column B is “Q”. Following the Substitution Process, “Q” is removed from Column B and moved to Column D. As the result, “Q” becomes the Substitution Character for the number “1”. See Table 11.
2. The second character in 1ST PASSWORD is “S” with a numerical value of 19. The 19^{th} character in Column B is “3”. Following the Substitution Process, “3” is removed from Column B and moved to Column D. As the result, “3” becomes the Substitution Character for the number “2”. See Table 12.
3. The third character in 1ST PASSWORD is “T” with a numerical value of 20. The 20^{th} character in Column B is “M”. Following the Substitution Process, “M” is removed from Column B and moved to Column D. As the result, “M” becomes the Substitution Character for the number “3”. See Table 13.

TABLE 11

| A | B | C | D |
|---|---|---|---|
| 1^{st} | 1 | 1 | Q |
| 2^{nd} | 2 | 2 | |
| 3^{rd} | 3 | 3 | |
| 4^{th} | 4 | 4 | |
| 5^{th} | 5 | 5 | |
| 6^{th} | 6 | 6 | |
| 7^{th} | 7 | 7 | |
| 8^{th} | 8 | 8 | |
| 9^{th} | 9 | 9 | |
| 10^{th} | 0 | 0 | |
| 11^{th} | A | A | |
| 12^{th} | B | B | |
| 13^{th} | C | C | |
| 14^{th} | D | D | |
| 15^{th} | E | E | |
| 16^{th} | F | F | |
| 17^{th} | G | G | |
| 18^{th} | H | H | |
| 19^{th} | I | I | |
| 20^{th} | J | J | |
| 21^{st} | K | K | |
| 22^{nd} | L | L | |
| 23^{rd} | M | M | |
| 24^{th} | N | N | |
| 25^{th} | O | O | |
| 26^{th} | P | P | |
| [symbol] | [symbol] | Q | |
| 28^{th} | R | R | |
| 29^{th} | S | S | |
| 30^{th} | T | T | |
| 31^{st} | U | U | |
| 32^{nd} | V | V | |
| 33^{rd} | W | W | |
| 34^{th} | X | X | |
| 35^{th} | Y | Y | |
| 36^{th} | Z | Z | |
| 37^{th} | spc | spc | |
| 38^{th} | ? | ? | |
| 39^{th} | ! | ! | |
| 40^{th} | $ | $ | |
| 41^{st} | % | % | |
| 42^{nd} | ( | ( | |
| 43^{rd} | ) | ) | |

TABLE 12

| A | B | C | D |
|---|---|---|---|
| 17^{th} | 1 | 1 | Q |
| 18^{th} | 2 | 2 | 3 |
| [symbol] | [symbol] | 3 | |
| 20^{th} | 4 | 4 | |
| 21^{st} | 5 | 5 | |
| 22^{nd} | 6 | 6 | |
| 23^{rd} | 7 | 7 | |
| 24^{th} | 8 | 8 | |
| 25^{th} | 9 | 9 | |
| 26^{th} | 0 | 0 | |
| 27^{th} | A | A | |
| 28^{th} | B | B | |
| 29^{th} | C | C | |
| 30^{th} | D | D | |
| 31^{st} | E | E | |
| 32^{nd} | F | F | |
| 33^{rd} | G | G | |
| 34^{th} | H | H | |
| 35^{th} | I | I | |
| 36^{th} | J | J | |
| 37^{th} | K | K | |
| 38^{th} | L | L | |
| 39^{th} | M | M | |
| 40^{th} | N | N | |
| 41^{st} | O | O | |
| 42^{nd} | P | P | |
| | | Q | |
| 1^{st} | R | R | |
| 2^{nd} | S | S | |
| 3^{rd} | T | T | |
| 4^{th} | U | U | |
| 5^{th} | V | V | |
| 6^{th} | W | W | |
| 7^{th} | X | X | |
| 8^{th} | Y | Y | |
| 9^{th} | Z | Z | |
| 10^{th} | spc | spc | |
| 11^{th} | ? | ? | |
| 12^{th} | ! | ! | |
| 13^{th} | $ | $ | |
| 14^{th} | % | % | |
| 15^{th} | ( | ( | |
| 16^{th} | ) | ) | |

TABLE 13

| A | B | C | D |
|---|---|---|---|
| 40^{th} | 1 | 1 | Q |
| 41^{st} | 2 | 2 | 3 |
| | | 3 | M |
| 1^{st} | 4 | 4 | |
| 2^{nd} | 5 | 5 | |
| 3^{rd} | 6 | 6 | |
| 4^{th} | 7 | 7 | |
| 5^{th} | 8 | 8 | |
| 6^{th} | 9 | 9 | |
| 7^{th} | 0 | 0 | |
| 8^{th} | A | A | |
| 9^{th} | B | B | |
| 10^{th} | C | C | |
| 11^{th} | D | D | |
| 12^{th} | E | E | |
| 13^{th} | F | F | |
| 14^{th} | G | G | |
| 15^{th} | H | H | |
| 16^{th} | I | I | |
| 17^{th} | J | J | |
| 18^{th} | K | K | |
| 19^{th} | L | L | |
| [symbol] | [symbol] | M | |
| 21^{st} | N | N | |
| 22^{nd} | O | O | |
| 23^{rd} | P | P | |
| | | Q | |
| 24^{th} | R | R | |
| 25^{th} | S | S | |
| 26^{th} | T | T | |
| 27^{th} | U | U | |
| 28^{th} | V | V | |
| 29^{th} | W | W | |
| 30^{th} | X | X | |
| 31^{st} | Y | Y | |
| 32^{nd} | Z | Z | |
| 33^{rd} | spc | spc | |
| 34^{th} | ? | ? | |
| 35^{th} | ! | ! | |
| 36^{th} | $ | $ | |
| 37^{th} | % | % | |
| 38^{th} | ( | ( | |
| 39^{th} | ) | ) | |

4. The fourth character in 1ST PASSWORD is a space with a numerical value of 37. The 37^{th} character in Column B is “I”. Following the Substitution Process, “I” is removed from Column B and moved to Column D. As the result, “I” becomes the Substitution Character for the number “4”.
5. The fifth character in 1ST PASSWORD is “P” with a numerical value of 16. The 16^{th} character in Column B is “spc”. Following the Substitution Process, “spc” is removed from Column B and moved to Column D. As a result, “spc” becomes the Substitution Character for the number “5”.
6. The sixth character in 1ST PASSWORD is “A” with a numerical value of 1. The 1^{st} character in Column B is “?”. Following the Substitution Process “?” is removed from Column B and moved to Column D. As a result, “?” becomes the Substitution Character for the number “6”.
7. The seventh character in 1ST PASSWORD is “S” with a numerical value of 19. The 19^{th} character in Column B is “E”. Following the Substitution Process, “E” is removed from Column B and moved to Column D. As the result, “E” becomes the Substitution Character for the number “7”.
8. The eight character in 1ST PASSWORD is also “S” with a numerical value of 19. The 19^{th} character in Column B is “!”. Following the Substitution Process, “!” is removed from Column B and moved to Column D. As the result, “!” becomes the Substitution Character for the number “8”.
9. The ninth character in 1ST PASSWORD is “W” with a numerical value of 23. The 23^{rd} character in Column B is “L”. Following the Substitution Process, “L” is removed from Column B and moved to Column D. As the result, “L” becomes the Substitution Character for the number “9”.
10. The tenth character in 1ST PASSWORD is “O” with a numerical value of 15. The 15^{th} character in Column B is “(”. Following the Substitution Process, “(” is removed from Column B and moved to Column D. As the result, “(” becomes the Substitution Character for the number “0”.
11. The eleventh character in 1ST PASSWORD is “R” with a numerical value of 18. The 18^{th} character in Column B is “J”. Following the Substitution Process, “J” is removed from Column B and moved to Column D. As the result, “J” becomes the Substitution Character for the letter “A”.
12. The twelfth character in 1ST PASSWORD is “D” with a numerical value of 4. The 4^{th} character in Column B is “P”. Following the Substitution Process, “P” is removed from Column B and moved to Column D. As the result, “P” becomes the Substitution Character for the letter “B”.
13. As a reminder, there are twelve characters in 1ST PASSWORD. Therefore, in order to obtain the thirteenth character, the “Numerical Character Sequence for Sample Password 1ST PASSWORD with Character Value Set Example 1” has to be used. The thirteenth character Numerical Character Sequence for Sample Password: 1ST PASSWORD and Character Value Set Example 1 is “1” with a numerical value of 27. The 27^{th} character in Column B is “G”. Following the Substitution Process, “G” is removed from Column B and moved to Column D. As the result, “G” becomes the Substitution Character for the letter “C”.
14. The fourteenth character in the “Numerical Character Sequence for Sample Password 1ST PASSWORD with Character Value Set Example 1” is “S” with a numerical value of 19. The 19^{th} character in Column B is “4”. Following the Substitution Process, “4” is removed from Column B and moved to Column D. As the result, “4” becomes the Substitution Character for the letter “D”.
15. The fifteenth character in the “Numerical Character Sequence for Sample Password 1ST PASSWORD with Character Value Set Example 1” is “T” with a numerical value of 20. The 20^{th} character in Column B is “V”. Following the Substitution Process, “V” is removed from Column B and moved to Column D. As the result, “V” becomes the Substitution Character for the letter “E”.
16. The sixteenth character in the “Numerical Character Sequence for Sample Password 1ST PASSWORD with Character Value Set Example 1” is “spc” with a numerical value of 37. Due to the ongoing Substitution Process, there are only twenty eight (28) characters remaining in Column B. Therefore, to obtain a character the 37^{th} character, the count in Column A has to be resumed (see Note 1). The 37^{th} character in Column B is “2”. Following the Substitution Process, “2” is removed from Column B and moved to Column D. As the result, “2” becomes the Substitution Character for the letter “F”.
17. The seventeenth character in the “Numerical Character Sequence for Sample Password 1ST PASSWORD with Character Value Set Example 1” is “P” with a numerical value of 16. The 16^{th} character in Column B is “R”. Following the Substitution Process, “R” is removed from Column B and moved to Column D. As the result, “R” becomes the Substitution Character for the letter “G”.
18. The eighteenth character in the “Numerical Character Sequence for Sample Password 1ST PASSWORD with Character Value Set Example 1” is “A” with a numerical value of 1. The 1^{st} character in Column B is “S”. Following the Substitution Process, “S” is removed from Column B and moved to Column D. As the result, “S” becomes the Substitution Character for the letter “H”.
19. The nineteenth character in the “Numerical Character Sequence for Sample Password 1ST PASSWORD with Character Value Set Example 1” is “S” with a numerical value of 19. The 19^{th} character in Column B is “C”. Following the Substitution Process, “C” is removed from Column B and moved to Column D. As the result, “C” becomes the Substitution Character for the letter “I”.
20. The twentieth character in the “Numerical Character Sequence for Sample Password 1ST PASSWORD with Character Value Set Example 1” is also “S” with a numerical value of 19. The 19^{th} character in Column B is “7”. Following the Substitution Process, “7” is removed from Column B and moved to Column D. As the result, “7” becomes the Substitution Character for the letter “J”.
21. The twenty first character in the “Numerical Character Sequence for Sample Password 1ST PASSWORD with Character Value Set Example 1” is “W” with a numerical value of 23. The 23^{rd} character in Column B is “6”. Following the Substitution Process, “6” is removed from Column B and moved to Column D. As the result, “6” becomes the Substitution Character for the letter “K”.
22. The twenty second character in the “Numerical Character Sequence for Sample Password 1ST PASSWORD with Character Value Set Example 1” is “O” with a numerical value of 15. The 15^{th} character in Column B is “X”. Following the Substitution Process, “X” is removed from Column B and moved to Column D. As the result, “X” becomes the Substitution Character for the letter “L”.
23. The twenty third character in the “Numerical Character Sequence for Sample Password 1ST PASSWORD with Character Value Set Example 1” is “R” with a numerical value of 18. The 18^{th} character in Column B is “O”. Following the Substitution Process, “O” is removed from Column B and moved to Column D. As the result, “O” becomes the Substitution Character for the letter “M”.
24. The twenty fourth character in the “Numerical Character Sequence for Sample Password 1ST PASSWORD with Character Value Set Example 1” is “D” with a numerical value of 4. The 4^{th} character in Column B is “Y”. Following the Substitution Process, “Y” is removed from Column B and moved to Column D. As the result, “Y” becomes the Substitution Character for the letter “N”.
25. The twenty fifth character in the “Numerical Character Sequence for Sample Password 1ST PASSWORD with Character Value Set Example 1” is “1” with a numerical value of 27. The 27^{th} character in Column B is “9”. Following the Substitution Process, “9” is removed from Column B and moved to Column D. As the result, “9” becomes the Substitution Character for the letter “O”. See Note 1.
26. The twenty sixth character in the “Numerical Character Sequence for Sample Password 1ST PASSWORD with Character Value Set Example 1” is “S” with a numerical value of 19. The 19^{th} character in Column B is “0”. Following the Substitution Process, “0” is removed from Column B and moved to Column D. As the result, “0” becomes the Substitution Character for the letter “P”.
27. The twenty seventh character in the “Numerical Character Sequence for Sample Password 1ST PASSWORD with Character Value Set Example 1” is “T” with a numerical value of 20. The 20^{th} character in Column B is “D”. Following the Substitution Process, “D” is removed from Column B and moved to Column D. As the result, “D” becomes the Substitution Character for the letter “Q”.
28. The twenty eight character in the “Numerical Character Sequence for Sample Password 1ST PASSWORD with Character Value Set Example 1” is “spc” with a numerical value of 37. The 37^{th} character in Column B is “T”. Following the Substitution Process, “T” is removed from Column B and moved to Column D. As the result, “T” becomes the Substitution Character for the letter “R”. See Note 1.
29. The twenty ninth character in the “Numerical Character Sequence for Sample Password 1ST PASSWORD with Character Value Set Example 1” is “P” with a numerical value of 16. The 16^{th} character in Column B is “U”. Following the Substitution Process, “U” is removed from Column B and moved to Column D. As the result, “U” becomes the Substitution Character for the letter “S”.
30. The thirtieth character in the “Numerical Character Sequence for Sample Password 1ST PASSWORD with Character Value Set Example 1” is “A” with a numerical value of 1. The 1^{st} character in Column B is “W”. Following the Substitution Process, “W” is removed from Column B and moved to Column D. As the result, “W” becomes the Substitution Character for the letter “T”.
31. The thirty first character in the “Numerical Character Sequence for Sample Password 1ST PASSWORD with Character Value Set Example 1” is “S” with a numerical value of 19. The 19^{th} character in Column B is “5”. Following the Substitution Process, “5” is removed from Column B and moved to Column D. As the result, “5” becomes the Substitution Character for the letter “U”. See Note 1.
32. The thirty second character in the “Numerical Character Sequence for Sample Password 1ST PASSWORD with Character Value Set Example 1” is also “S” with a numerical value of 19. The 19^{th} character in Column B is “N”. Following the Substitution Process, “N” is removed from Column B and moved to Column D. As the result, “N” becomes the Substitution Character for the letter “V”.
33. The thirty third character in the “Numerical Character Sequence for Sample Password 1ST PASSWORD with Character Value Set Example 1” is “W” with a numerical value of 23. The 23^{rd} character in Column B is “Z”. Following the Substitution Process, “Z” is removed from Column B and moved to Column D. As the result, “Z” becomes the Substitution Character for the letter “W”. See Note 1.
34. The thirty fourth character in the “Numerical Character Sequence for Sample Password 1ST PASSWORD with Character Value Set Example 1” is also “O” with a numerical value of 15. The 15^{th} character in Column B is “8”. Following the Substitution Process, “8” is removed from Column B and moved to Column D. As the result, “8” becomes the Substitution Character for the letter “X”. See Note 1.
35. The thirty fifth character in the “Numerical Character Sequence for Sample Password 1ST PASSWORD with Character Value Set Example 1” is “R” with a numerical value of 18. The 18^{th} character in Column B is “1”. Following the Substitution Process, “1” is removed from Column B and moved to Column D. As the result, “1” becomes the Substitution Character for the letter “Y”. See Note 1.
36. The thirty sixth character in the “Numerical Character Sequence for Sample Password 1ST PASSWORD with Character Value Set Example 1” is “D” with a numerical value of 4. The 4^{th} character in Column B is “H”. Following the Substitution Process, “H” is removed from Column B and moved to Column D. As the result, “H” becomes the Substitution Character for the letter “Z”.
37. The thirty seventh character in the “Numerical Character Sequence for Sample Password 1ST PASSWORD with Character Value Set Example 1” is “1” with a numerical value of 27. The 27^{th} character in Column B is “B”. Following the Substitution Process, “B” is removed from Column B and moved to Column D. As the result, “B” becomes the Substitution Character for the “spc”. See Note 1.
38. The thirty eighth character in the “Numerical Character Sequence for Sample Password 1ST PASSWORD with Character Value Set Example 1” is “S” with a numerical value of 19. The 19^{th} character in Column B is “F”. Following the Substitution Process, “F” is removed from Column B and moved to Column D. As the result, “F” becomes the Substitution Character for the “?”. See Note 1.
39. The thirty ninth character in the “Numerical Character Sequence for Sample Password 1ST PASSWORD with Character Value Set Example 1” is “T” with a numerical value of 20. The 20^{th} character in Column B is “A”. Following the Substitution Process, “A” is removed from Column B and moved to Column D. As the result, “A” becomes the Substitution Character for the “!”.
40. The fortieth character in the “Numerical Character Sequence for Sample Password 1ST PASSWORD with Character Value Set Example 1” is “spc” with a numerical value of 37. The 37^{th} character in Column B is” K”. Following the Substitution Process, “K” is removed from Column B and moved to Column D. As the result, “K” becomes the Substitution Character for the “$”. See Note 1.
41. The forty first character in the “Numerical Character Sequence for Sample Password 1ST PASSWORD with Character Value Set Example 1” is “P” with a numerical value of 16. The 16^{th} character in Column B is “$”. Following the Substitution Process, “$” is removed from Column B and moved to Column D. As the result, $“becomes the Substitution Character for the “%”.
42. The forty second character in the “Numerical Character Sequence for Sample Password 1ST PASSWORD with Character Value Set Example 1” is “A” with a numerical value of 1. The 1^{st} character in Column B is “%”. Following the Substitution Process, “%” is removed from Column B and moved to Column D. As the result, “%” becomes the Substitution Character for the “(”. See Table 42.
43. The forty third and last character in the” Numerical Character Sequence for Sample Password 1ST PASSWORD with Character Value Set Example 1” is “S” with a numerical value of 19. The last character in Column B is “)”. As the result, “)” becomes the Substitution Character for the “)” and completes the Substitution Process. See Note 1.
44. Table 14 represents the Final Coding Sequence for Example 1 utilizing the sample Character Set illustrated in Table 1, sample Character Value Set Example 1 illustrated in Table 2, sample Mixed Character Set illustrated in Table 4, sample Password 1ST PASSWORD along with its Numerical Character Sequence for Sample Password 1ST PASSWORD with Character Value Set Example 1 illustrated in Table 5, and the SECOND sample Substitution Process. See Table 14.

### Final Coding Sequence for Example 2

TABLE 14

| Column C | Column D |
|---|---|
| 1 | Q |
| 2 | 3 |
| 3 | M |
| 4 | I |
| 5 | spc |
| 6 | ? |
| 7 | E |
| 8 | ! |
| 9 | L |
| 0 | ( |
| A | J |
| B | P |
| C | G |
| D | 4 |
| E | V |
| F | 2 |
| G | R |
| H | S |
| I | C |
| J | 7 |
| K | 6 |
| L | X |
| M | O |
| N | Y |
| O | 9 |
| P | 0 |
| Q | D |
| R | T |
| S | U |
| T | W |
| U | 5 |
| V | N |
| W | Z |
| X | 8 |
| Y | 1 |
| Z | H |
| spc | B |
| ? | F |
| ! | A |
| $ | K |
| % | $ |
| ( | % |
| ) | ) |

To demonstrate the coding process using the Final Coding Sequence for Example 2 as listed in Table 14, the phrase

### SAMPLE CODING OF CHARACTER SET ABCDEFGHIJKLMNOPQRSTUVWXYZ1234567890

?!$%( )
translates into
UJO0XVBG94CYRB92BGSJTJGWVTBUVWBJPG4V2RSC76XOY90DTUW5NZ81HQ3MI
?E!L(BFAK$%)

### EXAMPLE 3

EXAMPLE 3 illustrates step by step Substitution Process utilizing the sample Character Set illustrated in Table 1, sample Character Value Set Example 2 illustrated in Table 3, sample Mixed Character Set illustrated in Table 4, sample Password 1ST PASSWORD along with its Numerical Character Sequence for Sample Password 1ST PASSWORD with Character Value Set Example 2 illustrated in Table 6, and the FIRST sample Substitution Process.
1. The first character in 1ST PASSWORD is “1” with a numerical value of 2. The 2^{nd} character in Column B is “2”. Following the Substitution Process, “2” is removed from Column B and moved to Column D. As the result, “2” becomes the Substitution Character for the number “1”. See Table 15.
2. The second character in 1ST PASSWORD is “S” with a numerical value of 4. The 4^{th} character in Column B is “5”. Following the Substitution Process, “5” is removed from Column B and moved to Column D. As the result, “5” becomes the Substitution Character for the number “2”. See Table 16.
3. The third character in 1ST PASSWORD is “T” with a numerical value of 5. The 5^{th} character in Column B is “7”. Following the Substitution Process, “7” is removed from Column B and moved to Column D. As the result, “7” becomes the Substitution Character for the number “3”. See Table 17.

TABLE 15

| A | B | C | D |
|---|---|---|---|
| 1^{st} | 1 | 1 | 2 |
| [symbol] | [symbol] | 2 | |
| 3^{rd} | 3 | 3 | |
| 4^{th} | 4 | 4 | |
| 5^{th} | 5 | 5 | |
| | 6 | 6 | |
| | 7 | 7 | |
| | 8 | 8 | |
| | 9 | 9 | |
| | 0 | 0 | |
| | A | A | |
| | B | B | |
| | C | C | |
| | D | D | |
| | E | E | |
| | F | F | |
| | G | G | |
| | H | H | |
| | I | I | |
| | J | J | |
| | K | K | |
| | L | L | |
| | M | M | |
| | N | N | |
| | O | O | |
| | P | P | |
| | Q | Q | |
| | R | R | |
| | S | S | |
| | T | T | |
| | U | U | |
| | V | V | |
| | W | W | |
| | X | X | |
| | Y | Y | |
| | Z | Z | |
| | spc | spc | |
| | ? | ? | |
| | ! | ! | |
| | $ | $ | |
| | % | % | |
| | ( | ( | |
| | ) | ) | |

TABLE 16

| A | B | C | D |
|---|---|---|---|
| 1^{st} | 1 | 1 | 2 |
| | | 2 | 5 |
| 2^{nd} | 3 | 3 | |
| 3^{rd} | 4 | 4 | |
| [symbol] | [symbol] | 5 | |
| 5^{th} | 6 | 6 | |
| | 7 | 7 | |
| | 8 | 8 | |
| | 9 | 9 | |
| | 0 | 0 | |
| | A | A | |
| | B | B | |
| | C | C | |
| | D | D | |
| | E | E | |
| | F | F | |
| | G | G | |
| | H | H | |
| | I | I | |
| | J | J | |
| | K | K | |
| | L | L | |
| | M | M | |
| | N | N | |
| | O | O | |
| | P | P | |
| | Q | Q | |
| | R | R | |
| | S | S | |
| | T | T | |
| | U | U | |
| | V | V | |
| | W | W | |
| | X | X | |
| | Y | Y | |
| | Z | Z | |
| | spc | spc | |
| | ? | ? | |
| | ! | ! | |
| | $ | $ | |
| | % | % | |
| | ( | ( | |
| | ) | ) | |

TABLE 17

| A | B | C | D |
|---|---|---|---|
| 1^{st} | 1 | 1 | 2 |
| | | 2 | 5 |
| 2^{nd} | 3 | 3 | 7 |
| 3^{rd} | 4 | 4 | |
| | | 5 | |
| 4^{th} | 6 | 6 | |
| [symbol] | [symbol] | 7 | |
| | 8 | 8 | |
| | 9 | 9 | |
| | 0 | 0 | |
| | A | A | |
| | B | B | |
| | C | C | |
| | D | D | |
| | E | E | |
| | F | F | |
| | G | G | |
| | H | H | |
| | I | I | |
| | J | J | |
| | K | K | |
| | L | L | |
| | M | M | |
| | N | N | |
| | O | O | |
| | P | P | |
| | Q | Q | |
| | R | R | |
| | S | S | |
| | T | T | |
| | U | U | |
| | V | V | |
| | W | W | |
| | X | X | |
| | Y | Y | |
| | Z | Z | |
| | spc | spc | |
| | ? | ? | |
| | ! | ! | |
| | $ | $ | |
| | % | % | |
| | ( | ( | |
| | ) | ) | |

4. The fourth character in 1ST PASSWORD is a space with a numerical value of 2. The 2^{nd} character in Column B is “3”. Following the Substitution Process, “3” is removed from Column B and moved to Column D. As the result, “3” becomes the Substitution Character for the number “4”.
5. The fifth character in 1ST PASSWORD is “P” with a numerical value of 1. The 1^{st} character in Column B is “1”. Following the Substitution Process, “1” is removed from Column B and moved to Column D. As a result, “1” becomes the Substitution Character for the number “5”.
6. The sixth character in 1ST PASSWORD is “A” with a numerical value of 1. The 1^{st} character in Column B is “4”. Following the Substitution Process “4” is removed from Column B and moved to Column D. As a result, “4” becomes the Substitution Character for the number “6”.
7. The seventh character in 1ST PASSWORD is “S” with a numerical value of 4. The 4^{th} character in Column B is “0”. Following the Substitution Process, “0” is removed from Column B and moved to Column D. As the result, “0” becomes the Substitution Character for the number “7”.
8. The eight character in 1ST PASSWORD is also “S” with a numerical value of 4. The 4^{th} character in Column B is “A”. Following the Substitution Process, “A” is removed from Column B and moved to Column D. As the result, “A” becomes the Substitution Character for the number “8”.
9. The ninth character in 1ST PASSWORD is “W” with a numerical value of 3. The 3^{rd} character in Column B is “9”. Following the Substitution Process, “9” is removed from Column B and moved to Column D. As the result, “9” becomes the Substitution Character for the number “9”.
10. The tenth character in 1ST PASSWORD is “O” with a numerical value of 5. The 5^{th} character in Column B is “D”. Following the Substitution Process, “D” is removed from Column B and moved to Column D. As the result, “D” becomes the Substitution Character for the number “0”.
11. The eleventh character in 1ST PASSWORD is “R” with a numerical value of 3. The 3^{rd} character in Column B is “B”. Following the Substitution Process, “B” is removed from Column B and moved to Column D. As the result, “B” becomes the Substitution Character for the letter “A”.
12. The twelfth character in 1ST PASSWORD is “D” with a numerical value of 4. The 4^{th} character in Column B is “E”. Following the Substitution Process, “E” is removed from Column B and moved to Column D. As the result, “E” becomes the Substitution Character for the letter “B”.
13. As a reminder, there are twelve characters in 1ST PASSWORD. Therefore, in order to obtain the thirteenth character, the “Numerical Character Sequence for Sample Password 1ST PASSWORD with Character Value Set Example 2” has to be used. The thirteenth character Numerical Character Sequence for Sample Password: 1ST PASSWORD and Character Value Set Example 2 is “1” with a numerical value of 2. The 2^{nd} character in Column B is “8”. Following the Substitution Process, “8” is removed from Column B and moved to Column D. As the result, “8” becomes the Substitution Character for the letter “C”.
14. The fourteenth character in the “Numerical Character Sequence for Sample Password 1ST PASSWORD with Character Value Set Example 2” is “S” with a numerical value of 4. The 4^{th} character in Column B is “G”. Following the Substitution Process, “G” is removed from Column B and moved to Column D. As the result, “G” becomes the Substitution Character for the letter “D”.
15. The fifteenth character in the “Numerical Character Sequence for Sample Password 1ST PASSWORD with Character Value Set Example 2” is “T” with a numerical value of 5. The 5^{th} character in Column B is “I”. Following the Substitution Process, “I” is removed from Column B and moved to Column D. As the result, “I” becomes the Substitution Character for the letter “E”.
16. The sixteenth character in the “Numerical Character Sequence for Sample Password 1ST PASSWORD with Character Value Set Example 2” is “spc” with a numerical value of 2. The 2^{nd} character in Column B is “C”. Following the Substitution Process, “C” is removed from Column B and moved to Column D. As the result, “C” becomes the Substitution Character for the letter “F”.
17. The seventeenth character in the “Numerical Character Sequence for Sample Password 1ST PASSWORD with Character Value Set Example 2” is “P” with a numerical value of 1. The 1^{st} character in Column B is “6”. Following the Substitution Process, “6” is removed from Column B and moved to Column D. As the result, “6” becomes the Substitution Character for the letter “G”.
18. The eighteenth character in the “Numerical Character Sequence for Sample Password 1ST PASSWORD with Character Value Set Example 2” is “A” with a numerical value of 1. The 1^{st} character in Column B is “F”. Following the Substitution Process, “F” is removed from Column B and moved to Column D. As the result, “F” becomes the Substitution Character for the letter “H”.
19. The nineteenth character in the “Numerical Character Sequence for Sample Password 1ST PASSWORD with Character Value Set Example 2” is “S” with a numerical value of 4. The 4^{th} character in Column B is “L”. Following the Substitution Process, “L” is removed from Column B and moved to Column D. As the result, “L” becomes the Substitution Character for the letter “I”.
20. The twentieth character in the “Numerical Character Sequence for Sample Password 1ST PASSWORD with Character Value Set Example 2” is also “S” with a numerical value of 4. The 4^{th} character in Column B is “M”. Following the Substitution Process, “M” is removed from Column B and moved to Column D. As the result, “M” becomes the Substitution Character for the letter “J”.
21. The twenty first character in the “Numerical Character Sequence for Sample Password 1ST PASSWORD with Character Value Set Example 2” is “W” with a numerical value of 3. The 3^{rd} character in Column B is “K”. Following the Substitution Process, “K” is removed from Column B and moved to Column D. As the result, “K” becomes the Substitution Character for the letter “K”.
22. The twenty second character in the “Numerical Character Sequence for Sample Password 1ST PASSWORD with Character Value Set Example 2” is “O” with a numerical value of 5. The 5^{th} character in Column B is “P”. Following the Substitution Process, “P” is removed from Column B and moved to Column D. As the result, “P” becomes the Substitution Character for the letter “L”.
23. The twenty third character in the “Numerical Character Sequence for Sample Password 1ST PASSWORD with Character Value Set Example 2” is “R” with a numerical value of 3. The 3^{rd} character in Column B is “N”. Following the Substitution Process, “N” is removed from Column B and moved to Column D. As the result, “N” becomes the Substitution Character for the letter “M”.
24. The twenty fourth character in the “Numerical Character Sequence for Sample Password 1ST PASSWORD with Character Value Set Example 2” is “D” with a numerical value of 4. The 4^{th} character in Column B is “Q”. Following the Substitution Process, “Q” is removed from Column B and moved to Column D. As the result, “Q” becomes the Substitution Character for the letter “N”.
25. The twenty fifth character in the “Numerical Character Sequence for Sample Password 1ST PASSWORD with Character Value Set Example 2” is “1” with a numerical value of 2. The 2nd character in Column B is “J”. Following the Substitution Process, “J” is removed from Column B and moved to Column D. As the result, “J” becomes the Substitution Character for the letter “O”.
26. The twenty sixth character in the “Numerical Character Sequence for Sample Password 1ST PASSWORD with Character Value Set Example 2” is “S” with a numerical value of 4. The 4^{th} character in Column B is “S”. Following the Substitution Process, “S” is removed from Column B and moved to Column D. As the result, “S” becomes the Substitution Character for the letter “P”.
27. The twenty seventh character in the “Numerical Character Sequence for Sample Password 1ST PASSWORD with Character Value Set Example 2” is “T” with a numerical value of 5. The 5^{th} character in Column B is “U”. Following the Substitution Process, “U” is removed from Column B and moved to Column D. As the result, “U” becomes the Substitution Character for the letter “Q”.
28. The twenty eight character in the “Numerical Character Sequence for Sample Password 1ST PASSWORD with Character Value Set Example 2” is “spc” with a numerical value of 2. The 2^{nd} character in Column B is “O”. Following the Substitution Process, “O” is removed from Column B and moved to Column D. As the result, “O” becomes the Substitution Character for the letter “R”.
29. The twenty ninth character in the “Numerical Character Sequence for Sample Password 1ST PASSWORD with Character Value Set Example 2” is “P” with a numerical value of 1. The 1^{st} character in Column B is “H”. Following the Substitution Process, “H” is removed from Column B and moved to Column D. As the result, “H” becomes the Substitution Character for the letter “S”.
30. The thirtieth character in the “Numerical Character Sequence for Sample Password 1ST PASSWORD with Character Value Set Example 2” is “A” with a numerical value of 1. The 1^{st} character in Column B is “R”. Following the Substitution Process, “R” is removed from Column B and moved to Column D. As the result, “R” becomes the Substitution Character for the letter “T”.
31. The thirty first character in the “Numerical Character Sequence for Sample Password 1ST PASSWORD with Character Value Set Example 2” is “S” with a numerical value of 4. The 4^{th} character in Column B is “X”. Following the Substitution Process, “X” is removed from Column B and moved to Column D. As the result, “X” becomes the Substitution Character for the letter “U”.
32. The thirty second character in the “Numerical Character Sequence for Sample Password 1ST PASSWORD with Character Value Set Example 2” is also “S” with a numerical value of 4. The 4^{th} character in Column B is “Y”. Following the Substitution Process, “Y” is removed from Column B and moved to Column D. As the result, “Y” becomes the Substitution Character for the letter “V”.
33. The thirty third character in the “Numerical Character Sequence for Sample Password 1ST PASSWORD with Character Value Set Example 2” is “W” with a numerical value of 3. The 3^{rd} character in Column B is “W”. Following the Substitution Process, “W” is removed from Column B and moved to Column D. As the result, “W” becomes the Substitution Character for the letter “W”.
34. The thirty fourth character in the “Numerical Character Sequence for Sample Password 1ST PASSWORD with Character Value Set Example 2” is also “O” with a numerical value of 5. The 5^{th} character in Column B is “?”. Following the Substitution Process, “?” is removed from Column B and moved to Column D. As the result, “?” becomes the Substitution Character for the letter “X”.
35. The thirty fifth character in the “Numerical Character Sequence for Sample Password 1ST PASSWORD with Character Value Set Example 2” is “R” with a numerical value of 3. The 3^{rd} character in Column B is “Z”. Following the Substitution Process, “Z” is removed from Column B and moved to Column D. As the result, “Z” becomes the Substitution Character for the letter “Y”.
36. The thirty sixth character in the “Numerical Character Sequence for Sample Password 1ST PASSWORD with Character Value Set Example 2” is “D” with a numerical value of 4. The 4^{th} character in Column B is “!”. Following the Substitution Process, “!” is removed from Column B and moved to Column D. As the result, becomes the Substitution Character for the letter “Z”.
37. The thirty seventh character in the “Numerical Character Sequence for Sample Password 1ST PASSWORD with Character Value Set Example 2” is “1” with a numerical value of 2. The 2^{nd} character in Column B is “V”. Following the Substitution Process, “V” is removed from Column B and moved to Column D. As the result, “V” becomes the Substitution Character for the “spc”.
38. The thirty eighth character in the “Numerical Character Sequence for Sample Password 1ST PASSWORD with Character Value Set Example 2” is “S” with a numerical value of 4. The 4^{th} character in Column B is “%”. Following the Substitution Process, “%” is removed from Column B and moved to Column D. As the result, “%” becomes the Substitution Character for the “?”.
39. The thirty ninth character in the “Numerical Character Sequence for Sample Password 1ST PASSWORD with Character Value Set Example 2” is “T” with a numerical value of 5. The 5^{th} character in Column B is “)”. Following the Substitution Process, “)” is removed from Column B and moved to Column D. As the result, “)” becomes the Substitution Character for the “!”.
40. The fortieth character in the “Numerical Character Sequence for Sample Password 1ST PASSWORD with Character Value Set Example 2” is “spc” with a numerical value of 2. The 2^{nd} character in Column B is “spc”. Following the Substitution Process, “spc” is removed from Column B and moved to Column D. As the result, “spc” becomes the Substitution Character for the “$”.
41. The forty first character in the “Numerical Character Sequence for Sample Password 1ST PASSWORD with Character Value Set Example 2” is “P” with a numerical value of 1. The 1^{st} character in Column B is “T”. Following the Substitution Process, “T” is removed from Column B and moved to Column D. As the result, “T” becomes the Substitution Character for the “%”.
42. The forty second character in the “Numerical Character Sequence for Sample Password 1ST PASSWORD with Character Value Set Example 2” is “A” with a numerical value of 1. The 1^{st} character in Column B is “$”. Following the Substitution Process, “$” is removed from Column B and moved to Column D. As the result, $“becomes the Substitution Character for the “(”.
43. The forty third and last character in the “Numerical Character Sequence for Sample Password 1ST PASSWORD with Character Value Set Example 2” is “S” with a numerical value of 4. The last character in Column B is “(”. As the result, “(” becomes the Substitution Character for the “)” and completes the Substitution Process.
44. Table 18 represents the Final Coding Sequence for Example 3 utilizing the sample Character Set illustrated in Table 1, sample Character Value Set Example 2 illustrated in Table 3, sample Mixed Character Set illustrated in Table 4, sample Password 1ST PASSWORD along with its Numerical Character Sequence for Sample Password 1ST PASSWORD with Character Value Set Example 2 illustrated in Table 6, and the FIRST sample Substitution Process. See Table 18.

### Final Coding Sequence for Example 3

TABLE 18

| Column C | Column D |
|---|---|
| 1 | 2 |
| 2 | 5 |
| 3 | 7 |
| 4 | 3 |
| 5 | 1 |
| 6 | 4 |
| 7 | 0 |
| 8 | A |
| 9 | 9 |
| 0 | D |
| A | B |
| B | E |
| C | 8 |
| D | G |
| E | I |
| F | C |
| G | 6 |
| H | F |
| I | L |
| J | M |
| K | K |
| L | P |
| M | N |
| N | Q |
| O | J |
| P | S |
| Q | U |
| R | O |
| S | H |
| T | R |
| U | X |
| V | Y |
| W | W |
| X | ? |
| Y | Z |
| Z | ! |
| spc | V |
| ? | % |
| ! | ) |
| $ | spc |
| % | T |
| ( | $ |
| ) | ( |

To demonstrate the coding process using the Final Coding Sequence for Example 3 as listed in Table 18, the phrase

### SAMPLE CODING OF CHARACTER SET ABCDEFGHIJKLMNOPQRSTUVWXYZ1234567890

?!$%()
translates into
HBNSPIV8JGLQ6VJCV8FBOB8RIOVHIRVBE8GIC6FLMKPNQJSUOHRXYW?Z!2573140A9D V%) T$(

### EXAMPLE 4

EXAMPLE 4 illustrates step by step Substitution Process utilizing the sample Character Set illustrated in Table 1, sample Character Value Set Example 2 illustrated in Table 3, sample Mixed Character Set illustrated in Table 4, sample Password 1ST PASSWORD along with its Numerical Character Sequence for Sample Password 1ST PASSWORD with Character Value Set Example 2 illustrated in Table 6, and the SECOND sample Substitution Process.
1. The first character in 1ST PASSWORD is “1” with a numerical value of 2. The 2^{nd} character in Column B is “2”. Following the Substitution Process, “2” is removed from Column B and moved to Column D. As the result, “2” becomes the Substitution Character for the number “1”. See Table 19.
2. The second character in 1ST PASSWORD is “S” with a numerical value of 4. The 4^{th} character in Column B is “6”. Following the Substitution Process, “6” is removed from Column B and moved to Column D. As the result, “6” becomes the Substitution Character for the number “2”. See Table 20.
3. The third character in 1ST PASSWORD is “T” with a numerical value of 5. The 5^{th} character in Column B is “A”. Following the Substitution Process, “A” is removed from Column B and moved to Column D. As the result, “A” becomes the Substitution Character for the number “3”. See Table 21.

TABLE 19

| A | B | C | D |
|---|---|---|---|
| 1^{st} | 1 | 1 | 2 |
| [symbol] | [symbol] | 2 | |
| 3^{rd} | 3 | 3 | |
| 4^{th} | 4 | 4 | |
| 5^{th} | 5 | 5 | |
| | 6 | 6 | |
| | 7 | 7 | |
| | 8 | 8 | |
| | 9 | 9 | |
| | 0 | 0 | |
| | A | A | |
| | B | B | |
| | C | C | |
| | D | D | |
| | E | E | |
| | F | F | |
| | G | G | |
| | H | H | |
| | I | I | |
| | J | J | |
| | K | K | |
| | L | L | |
| | M | M | |
| | N | N | |
| | O | O | |
| | P | P | |
| | Q | Q | |
| | R | R | |
| | S | S | |
| | T | T | |
| | U | U | |
| | V | V | |
| | W | W | |
| | X | X | |
| | Y | Y | |
| | Z | Z | |
| | spc | spc | |
| | ? | ? | |
| | ! | ! | |
| | $ | $ | |
| | % | % | |
| | ( | ( | |
| | ) | ) | |

TABLE 20

| A | B | C | D |
|---|---|---|---|
| | 1 | 1 | 2 |
| | | 2 | 6 |
| 1^{st} | 3 | 3 | |
| 2^{nd} | 4 | 4 | |
| 3^{rd} | 5 | 5 | |
| [symbol] | [symbol] | 6 | |
| 5^{th} | 7 | 7 | |
| | 8 | 8 | |
| | 9 | 9 | |
| | 0 | 0 | |
| | A | A | |
| | B | B | |
| | C | C | |
| | D | D | |
| | E | E | |
| | F | F | |
| | G | G | |
| | H | H | |
| | I | I | |
| | J | J | |
| | K | K | |
| | L | L | |
| | M | M | |
| | N | N | |
| | O | O | |
| | P | P | |
| | Q | Q | |
| | R | R | |
| | S | S | |
| | T | T | |
| | U | U | |
| | V | V | |
| | W | W | |
| | X | X | |
| | Y | Y | |
| | Z | Z | |
| | spc | spc | |
| | ? | ? | |
| | ! | ! | |
| | $ | $ | |
| | % | % | |
| | ( | ( | |
| | ) | ) | |

TABLE 21

| A | B | C | D |
|---|---|---|---|
| | 1 | 1 | 2 |
| | | 2 | 6 |
| | 3 | 3 | A |
| | 4 | 4 | |
| | 5 | 5 | |
| | | 6 | |
| 1^{st} | 7 | 7 | |
| 2^{nd} | 8 | 8 | |
| 3^{rd} | 9 | 9 | |
| 4^{th} | 0 | 0 | |
| [symbol] | [symbol] | A | |
| | B | B | |
| | C | C | |
| | D | D | |
| | E | E | |
| | F | F | |
| | G | G | |
| | H | H | |
| | I | I | |
| | J | J | |
| | K | K | |
| | L | L | |
| | M | M | |
| | N | N | |
| | O | O | |
| | P | P | |
| | Q | Q | |
| | R | R | |
| | S | S | |
| | T | T | |
| | U | U | |
| | V | V | |
| | W | W | |
| | X | X | |
| | Y | Y | |
| | Z | Z | |
| | spc | spc | |
| | ? | ? | |
| | ! | ! | |
| | $ | $ | |
| | % | % | |
| | ( | ( | |
| | ) | ) | |

4. The fourth character in 1ST PASSWORD is a space with a numerical value of 2. The 2^{nd} character in Column B is “C”. Following the Substitution Process, “C” is removed from Column B and moved to Column D. As the result, “C” becomes the Substitution Character for the number “4”.
5. The fifth character in 1ST PASSWORD is “P” with a numerical value of 1. The 1^{st} character in Column B is “D”. Following the Substitution Process, “D” is removed from Column B and moved to Column D. As a result, “D” becomes the Substitution Character for the number “5”.
6. The sixth character in 1ST PASSWORD is “A” with a numerical value of 1. The 1^{st} character in Column B is “E”. Following the Substitution Process “E” is removed from Column B and moved to Column D. As a result, “E” becomes the Substitution Character for the number “6”.
7. The seventh character in 1ST PASSWORD is “S” with a numerical value of 4. The 4^{th} character in Column B is “I”. Following the Substitution Process, “I” is removed from Column B and moved to Column D. As the result, “I” becomes the Substitution Character for the number “7”.
8. The eight character in 1ST PASSWORD is also “S” with a numerical value of 4. The 4^{th} character in Column B is “M”. Following the Substitution Process, “M” is removed from Column B and moved to Column D. As the result, “M” becomes the Substitution Character for the number “8”.
9. The ninth character in 1ST PASSWORD is “W” with a numerical value of 3. The 3^{rd} character in Column B is “P”. Following the Substitution Process, “P” is removed from Column B and moved to Column D. As the result, “P” becomes the Substitution Character for the number “9”.
10. The tenth character in 1ST PASSWORD is “O” with a numerical value of 5. The 5^{th} character in Column B is “U”. Following the Substitution Process, “U” is removed from Column B and moved to Column D. As the result, “U” becomes the Substitution Character for the number “0”.
11. The eleventh character in 1ST PASSWORD is “R” with a numerical value of 3. The 3^{rd} character in Column B is “X”. Following the Substitution Process, “X” is removed from Column B and moved to Column D. As the result, “X” becomes the Substitution Character for the letter “A”.
12. The twelfth character in 1ST PASSWORD is “D” with a numerical value of 4. The 4^{th} character in Column B is “?”. Following the Substitution Process, “?” is removed from Column B and moved to Column D. As the result, “?” becomes the Substitution Character for the letter “B”.
13. As a reminder, there are twelve characters in 1ST PASSWORD. Therefore, in order to obtain the thirteenth character, the “Numerical Character Sequence for Sample Password 1ST PASSWORD with Character Value Set Example 2” has to be used. The thirteenth character Numerical Character Sequence for Sample Password: 1ST PASSWORD and Character Value Set Example 2 is “1” with a numerical value of 2. The 2^{nd} character in Column B is “$”. Following the Substitution Process, “$” is removed from Column B and moved to Column D. As the result, “$” becomes the Substitution Character for the letter “C”.
14. The fourteenth character in the “Numerical Character Sequence for Sample Password 1ST PASSWORD with Character Value Set Example 2” is “S” with a numerical value of 4. The 4^{th} character in Column B is “1”. Following the Substitution Process, “1” is removed from Column B and moved to Column D. As the result, “1” becomes the Substitution Character for the letter “D”.
15. The fifteenth character in the “Numerical Character Sequence for Sample Password 1ST PASSWORD with Character Value Set Example 2” is “T” with a numerical value of 5. The 5^{th} character in Column B is “8”. Following the Substitution Process, “8” is removed from Column B and moved to Column D. As the result, “8” becomes the Substitution Character for the letter “E”.
16. The sixteenth character in the “Numerical Character Sequence for Sample Password 1ST PASSWORD with Character Value Set Example 2” is “spc” with a numerical value of 2. The 2^{nd} character in Column B is “0”. Following the Substitution Process, “0” is removed from Column B and moved to Column D. As the result, “0” becomes the Substitution Character for the letter “F”.
17. The seventeenth character in the “Numerical Character Sequence for Sample Password 1ST PASSWORD with Character Value Set Example 2” is “P” with a numerical value of 1. The 1^{st} character in Column B is “B”. Following the Substitution Process, “B” is removed from Column B and moved to Column D. As the result, “B” becomes the Substitution Character for the letter “G”.
18. The eighteenth character in the “Numerical Character Sequence for Sample Password 1ST PASSWORD with Character Value Set Example 2” is “A” with a numerical value of 1. The 1^{st} character in Column B is “F”. Following the Substitution Process, “F” is removed from Column B and moved to Column D. As the result, “F” becomes the Substitution Character for the letter “H”.
19. The nineteenth character in the “Numerical Character Sequence for Sample Password 1ST PASSWORD with Character Value Set Example 2” is “S” with a numerical value of 4. The 4^{th} character in Column B is “K”. Following the Substitution Process, “K” is removed from Column B and moved to Column D. As the result, “K” becomes the Substitution Character for the letter “I”.
20. The twentieth character in the “Numerical Character Sequence for Sample Password 1ST PASSWORD with Character Value Set Example 2” is also “S” with a numerical value of 4. The 4^{th} character in Column B is “Q”. Following the Substitution Process, “Q” is removed from Column B and moved to Column D. As the result, “Q” becomes the Substitution Character for the letter “J”.
21. The twenty first character in the “Numerical Character Sequence for Sample Password 1ST PASSWORD with Character Value Set Example 2” is “W” with a numerical value of 3. The 3^{rd} character in Column B is “T”. Following the Substitution Process, “T” is removed from Column B and moved to Column D. As the result, “T” becomes the Substitution Character for the letter “K”.
22. The twenty second character in the “Numerical Character Sequence for Sample Password 1ST PASSWORD with Character Value Set Example 2” is “O” with a numerical value of 5. The 5^{th} character in Column B is “spc”. Following the Substitution Process, “spc” is removed from Column B and moved to Column D. As the result, “spc” becomes the Substitution Character for the letter “L”.
23. The twenty third character in the “Numerical Character Sequence for Sample Password 1ST PASSWORD with Character Value Set Example 2” is “R” with a numerical value of 3. The 3^{rd} character in Column B is “(”. Following the Substitution Process, “(” is removed from Column B and moved to Column D. As the result, “(” becomes the Substitution Character for the letter “M”.
24. The twenty fourth character in the “Numerical Character Sequence for Sample Password 1ST PASSWORD with Character Value Set Example 2” is “D” with a numerical value of 4. The 4^{th} character in Column B is “5”. Following the Substitution Process, “5” is removed from Column B and moved to Column D. As the result, “5” becomes the Substitution Character for the letter “N”.
25. The twenty fifth character in the “Numerical Character Sequence for Sample Password 1ST PASSWORD with Character Value Set Example 2” is “1” with a numerical value of 2. The 2^{nd} character in Column B is “9”. Following the Substitution Process, “9” is removed from Column B and moved to Column D. As the result, “9” becomes the Substitution Character for the letter “O”.
26. The twenty sixth character in the “Numerical Character Sequence for Sample Password 1ST PASSWORD with Character Value Set Example 2” is “S” with a numerical value of 4. The 4^{th} character in Column B is “L”. Following the Substitution Process, “L” is removed from Column B and moved to Column D. As the result, “L” becomes the Substitution Character for the letter “P”.
27. The twenty seventh character in the “Numerical Character Sequence for Sample Password 1ST PASSWORD with Character Value Set Example 2” is “T” with a numerical value of 5. The 5^{th} character in Column B is “V”. Following the Substitution Process, “V” is removed from Column B and moved to Column D. As the result, “V” becomes the Substitution Character for the letter “Q”.
28. The twenty eight character in the “Numerical Character Sequence for Sample Password 1ST PASSWORD with Character Value Set Example 2” is “spc” with a numerical value of 2. The 2^{nd} character in Column B is “Y”. Following the Substitution Process, “Y” is removed from Column B and moved to Column D. As the result, “Y” becomes the Substitution Character for the letter “R”.
29. The twenty ninth character in the “Numerical Character Sequence for Sample Password 1ST PASSWORD with Character Value Set Example 2” is “P” with a numerical value of 1. The 1^{st} character in Column B is “Z”. Following the Substitution Process, “Z” is removed from Column B and moved to Column D. As the result, “Z” becomes the Substitution Character for the letter “S”.
30. The thirtieth character in the “Numerical Character Sequence for Sample Password 1ST PASSWORD with Character Value Set Example 2” is “A” with a numerical value of 1. The 1^{st} character in Column B is “!”. Following the Substitution Process, “!” is removed from Column B and moved to Column D. As the result, becomes the Substitution Character for the letter “T”.
31. The thirty first character in the “Numerical Character Sequence for Sample Password 1ST PASSWORD with Character Value Set Example 2” is “S” with a numerical value of 4. The 4^{th} character in Column B is “4”. Following the Substitution Process, “4” is removed from Column B and moved to Column D. As the result, “4” becomes the Substitution Character for the letter “U”.
32. The thirty second character in the “Numerical Character Sequence for Sample Password 1ST PASSWORD with Character Value Set Example 2” is also “S” with a numerical value of 4. The 4^{th} character in Column B is “J”. Following the Substitution Process, “J” is removed from Column B and moved to Column D. As the result, “J” becomes the Substitution Character for the letter “V”.
33. The thirty third character in the “Numerical Character Sequence for Sample Password 1ST PASSWORD with Character Value Set Example 2” is “W” with a numerical value of 3. The 3^{rd} character in Column B is “R”. Following the Substitution Process, “R” is removed from Column B and moved to Column D. As the result, “R” becomes the Substitution Character for the letter “W”.
34. The thirty fourth character in the “Numerical Character Sequence for Sample Password 1ST PASSWORD with Character Value Set Example 2” is also “O” with a numerical value of 5. The 5^{th} character in Column B is “3”. Following the Substitution Process, “3” is removed from Column B and moved to Column D. As the result, “3” becomes the Substitution Character for the letter “X”.
35. The thirty fifth character in the “Numerical Character Sequence for Sample Password 1ST PASSWORD with Character Value Set Example 2” is “R” with a numerical value of 3. The 3^{rd} character in Column B is “H”. Following the Substitution Process, “H” is removed from Column B and moved to Column D. As the result, “H” becomes the Substitution Character for the letter “Y”.
36. The thirty sixth character in the “Numerical Character Sequence for Sample Password 1ST PASSWORD with Character Value Set Example 2” is “D” with a numerical value of 4. The 4^{th} character in Column B is “W”. Following the Substitution Process, “W” is removed from Column B and moved to Column D. As the result, “W” becomes the Substitution Character for the letter “Z”.
37. The thirty seventh character in the “Numerical Character Sequence for Sample Password 1ST PASSWORD with Character Value Set Example 2” is “1” with a numerical value of 2. The 2^{nd} character in Column B is “)”. Following the Substitution Process, “)” is removed from Column B and moved to Column D. As the result, “)” becomes the Substitution Character for the “spc”.
38. The thirty eighth character in the “Numerical Character Sequence for Sample Password 1ST PASSWORD with Character Value Set Example 2” is “S” with a numerical value of 4. The 4^{th} character in Column B is “O”. Following the Substitution Process, “O” is removed from Column B and moved to Column D. As the result, “O” becomes the Substitution Character for the “?”.
39. The thirty ninth character in the “Numerical Character Sequence for Sample Password 1ST PASSWORD with Character Value Set Example 2” is “T” with a numerical value of 5. The 5^{th} character in Column B is “N”. Following the Substitution Process, “N” is removed from Column B and moved to Column D. As the result, “N” becomes the Substitution Character for the “!”.
40. The fortieth character in the “Numerical Character Sequence for Sample Password 1ST PASSWORD with Character Value Set Example 2” is “spc” with a numerical value of 2. The 2^{nd} character in Column B is “%”. Following the Substitution Process, “%” is removed from Column B and moved to Column D. As the result, “%” becomes the Substitution Character for the “$”.
41. The forty first character in the “Numerical Character Sequence for Sample Password 1ST PASSWORD with Character Value Set Example 2” is “P” with a numerical value of 1. The 1^{st} character in Column B is “7”. Following the Substitution Process, “7” is removed from Column B and moved to Column D. As the result, “7” becomes the Substitution Character for the “%”.
42. The forty second character in the “Numerical Character Sequence for Sample Password 1ST PASSWORD with Character Value Set Example 2” is “A” with a numerical value of 1. The 1^{st} character in Column B is “G”. Following the Substitution Process, “G” is removed from Column B and moved to Column D. As the result, “G” becomes the Substitution Character for the “(”.
43. The forty third and last character in the “Numerical Character Sequence for Sample Password 1ST PASSWORD with Character Value Set Example 2” is “S” with a numerical value of 4. The last character in Column B is “S”. As the result, “S” becomes the Substitution Character for the “)” and completes the Substitution Process.
44. Table 22 represents the Final Coding Sequence for Example 3 utilizing the sample Character Set illustrated in Table 1, sample Character Value Set Example 2 illustrated in Table 3, sample Mixed Character Set illustrated in Table 4, sample Password 1ST PASSWORD along with its Numerical Character Sequence for Sample Password 1ST PASSWORD with Character Value Set Example 2 illustrated in Table 6, and the SECOND sample Substitution Process. See Table 22.

### Final Coding Sequence for Example 4

TABLE 22

| Column C | Column D |
|---|---|
| 1 | 2 |
| 2 | 6 |
| 3 | A |
| 4 | C |
| 5 | D |
| 6 | E |
| 7 | I |
| 8 | M |
| 9 | P |
| 0 | U |
| A | X |
| B | ? |
| C | $ |
| D | 1 |
| E | 8 |
| F | 0 |
| G | B |
| H | F |
| I | K |
| J | Q |
| K | T |
| L | spc |
| M | ( |
| N | 5 |
| O | 9 |
| P | L |
| Q | V |
| R | Y |
| S | Z |
| T | ! |
| U | 4 |
| V | J |
| W | R |
| X | 3 |
| Y | H |
| Z | W |
| spc | ) |
| ? | O |
| ! | N |
| $ | % |
| % | 7 |
| ( | G |
| ) | S |

To demonstrate the coding process using the Final Coding Sequence for Example 4 as listed in Table 22, the phrase

### SAMPLE CODING OF CHARACTER SET ABCDEFGHIJKLMNOPQRSTUVWXYZ1234567890

?!$%()
translates into
ZX(L8)$91K5B)90)$FXYX$!8Y)Z8!)X?$180BFKQT (59LVYZ!4JR3HW26ACDEIMPU)ON%7GS

What is claimed is:

1. A Method for coding and decoding information utilizing a Character Set containing in any order any or all upper or lower case letters, with or without numbers, with or without symbols, with or without punctuation marks, with or without spaces, with or without special characters, with or without graphic symbols, and/or with or without any other characters found on any keyboard in any language; a Character Value Set in which each character within the selected Character Set is assigned a positive numerical value from 1 up. The numerical value assigned to each character within the Character Value Set may but does not have to be unique. Unique means that the same numerical value may be assigned to more then one character within the selected Character Set; a Mixed Character Sequence Set in which the characters within the selected Character Set are listed in any conceivable sequential order; a Password composed of as little as one or up to as many characters as there are within the selected Character Set which characters can be used once or repeatedly and where each of the characters has an assigned numerical value as determined by a selected Numerical Character Sequence; and a Substitution Process in which a Substitution Character is assigned for each of the characters in the Character Set that will be used for coding and decoding information.

2. In the Method as claimed in claim 1, Password can be composed of as little as one or up to as many characters as there are within the selected Character Set. The characters within a Password may be used once or repeatedly. A Numerical Character Sequence must be created meaning that the number of characters within a Password equals the number of characters within the selected Character Set. When the number of characters within a Password is less than the number of characters that there are within the selected Character Set, a formula has to be used. In that formula, the number of characters within the selected Character Set is divided by the number of characters within a Password. The result of that formula determines how many times the Password has to be repeated in order to obtain the number of characters contained within the selected Character Set. Once the formula is computed, the characters within the Password are repeated by the result of the formula and a Numerical Character Sequence can be created.

3. In the Method as claimed in claim 1, a Substitution Process needs to be carried out. In a Substitution Process a Substitution Character is assigned for each of the characters in the Character Set. In order to carry out the Substitution Process, four columns need to be created. Instead of columns, rows or any other format can be used as long as there are four locations where the Sequential Order of Mixed Characters, the Mixed Character Sequence Set, a mirror image of the Mixed Character Sequence Set, and the Substitution Character Set can be listed. The Substitution Character Set is created by using consecutive Numerical Character Sequence of the Password to identify the corresponding characters in the Mixed Character Sequence Set. As the Substitution Process continues, the number of characters in the Mixed Character Sequence Set decreases along with their corresponding Sequential Order of Mixed Characters and the number of characters in the Substitution Characters increases creating the Substitution Character Set. Once all of the characters in the Mixed Character Sequence Set are removed, all of the characters in the mirror image of the Mixed Character Sequence Set have a corresponding Substitution Character in the Substitution Character list and the Substitution Character Set is created. Once the Substitution Character Set is created, any information utilizing characters from within the Character Set can be coded and decoded. There are many ways of conducting the Substitution Process. One example of a Substitution Process is based on selection of Substitution Characters by utilizing the Numerical Character Sequence count always starting from the very first available character in the Mixed Character Sequence Set. Another example of a Substitution Process is based on selection of Substitution Characters from the Mixed Character Sequence Set starting from the next character following a character last moved from the Mixed Character Sequence Set to the Substitution Character Set. Other ways of conducting Substitution Process can be based on any pre-determined set of rules. For example: selection of Substitution Characters from the Mixed Character Sequence Set starting from any pre-determined position, counting of the characters by omitting every other character, or counting of the characters backwards. The number of possibilities is endless. The Substitution Process can be conducted utilizing a computer software or can be carried out by hand.

4. In the Method as claimed in claim 1, the Coding Process is based on substitution of characters in the Mixed Character Sequence Set with corresponding Characters in the Substitution Character Set. The Decoding Process is based on substitution of characters in the Substitution Character Set with the corresponding Characters in the Mixed Character Sequence Set. The coding and decoding can be utilized in any number of applications such as computer softwares, games, puzzles, e-mail, encryption, text messaging, or any other conceivable application.
